(19) United States
(12) Patent Application Publication
(10) Pub. No.: US 2026/0361335 A1
(43) Pub. Date: Nov. 12, 2026

(54) Dither Generation For Radio Frequency Sampling Digital-To-Analog Converters

(71) Applicant: TEXAS INSTRUMENTS INCORPORATED, Dallas, TX (US)

(72) Inventors: Harsh Garg, Delhi (IN); Sriram Murali, Bangalore (IN); Jaiganesh Balakrishnan, Bangalore (IN); Shankar Kadam, AURANGABAD (IN); Ram Narayan Krishna Nama Mony, Bangalore (IN); Kapil Kumar, New Delhi (IN); Vinit Shinde, Pune (IN)

(21) Appl. No.: 19/645,028

(22) Filed: Apr. 10, 2026

(30) Foreign Application Priority Data
Apr. 11, 2025 (IN) 202541035945

(51) Int. Cl. H04B 1/69; H04B 1/10

(52) U.S. Cl. CPC H04B 1/69; H04B 1/10

(57) ABSTRACT

A device is disclosed herein. The device includes a dither signal generation circuit that includes a controller configurable to generate a first signal and a second signal, a noise generation circuit configurable to receive the first signal from the controller and generate a noise signal responsive to the first signal, and a spreading sequence circuit. The spreading sequence circuit is configurable to spread the noise signal to generate a first waveform using a first spreading code responsive to the second signal having a first value and spread the noise signal to generate a second waveform using a second spreading code responsive to the second signal having a second value.

### CROSS-REFERENCE TO RELATED APPLICATIONS

This application claims priority to India Provisional Patent Application No. 202541035945, filed Apr. 11, 2025, which Application is hereby incorporated herein by reference in its entirety.

### BACKGROUND

Radio frequency (RF) sampling digital-to-analog converters (DACs) are becoming more widely used. For example, RF sampling DACs are becoming increasingly used in wireless base stations, user equipment, RADAR systems, etc. RF sampling DACs reduce the need for mixers in the RF/analog portion of the wireless base station's transmitter. Wireless base stations have stringent requirements related to spurious emissions. For example, a tolerable spurious level may be −85 dBc. Many current steering DACs are implemented as a set of thermometric current sources and a set of binary-weighted current sources. Each current source may force current through a corresponding resistor. Current source mismatches (both static and dynamic) in the DAC can limit its spurious performance due, for example, to high Integral Nonlinearity (INL). The third harmonic distortion (HD3), the fifth harmonic distortion (HD5), and intermodulation distortion (often, IMD2 or IMD3) may be impacted by current source mismatches. In turn, adjacent channel power ratio (ACPR) may be worsened and spectral emissions may occur which may impose design hardships on filters to filter out the spurious emissions.

### SUMMARY

A device is disclosed herein. The device includes a dither signal generation circuit that includes a controller configurable to generate a first signal and a second signal, a noise generation circuit configurable to receive the first signal from the controller and generate a noise signal responsive to the first signal, and a spreading sequence circuit. The spreading sequence circuit is configurable to spread the noise signal to generate a first waveform using a first spreading code responsive to the second signal having a first value and spread the noise signal to generate a second waveform using a second spreading code responsive to the second signal having a second value.

Also disclosed herein is a system. The system includes a digital-to-analog converter (DAC) configurable to provide an output for a radio transmitter and a dither signal generation circuit coupled to the DAC. The dither signal generation circuit includes a controller configurable to provide a waveform index signal and a trigger signal, a noise generation circuit coupled to the controller and configurable to generate a noise signal responsive to the trigger signal, and a spreading sequence circuit coupled to the controller. The spreading sequence circuit is configurable to spread the noise signal to generate a waveform based on the waveform index signal and the noise signal. The spreading sequence circuit includes a first spreading sequence that generates a first waveform in response to the waveform index signal having a first value and a second spreading sequence that generates a second waveform in response to the waveform index signal having a second value.

Also disclosed herein is a method. The method includes generating, by a noise generation circuit, a first noise signal in response to a first signal from a controller, outputting, by a spreading sequence circuit, a first waveform based on the first noise signal responsive to a second signal from the controller having a first value, and outputting, by the spreading sequence circuit, a second waveform based on the first noise signal responsive to the second signal from the controller having a second value.

The foregoing features and elements may be combined in any combination, without exclusivity, unless expressly indicated herein otherwise. These features and elements as well as the operation of the disclosed examples will become more apparent in light of the following description and accompanying drawings.

### BRIEF DESCRIPTION OF THE DRAWINGS

Reference will now be made to the accompanying drawings, which are not necessarily drawn to scale. While the drawings illustrate various examples employing the principles described herein, the drawings do not limit the scope of the claims.

FIG. 1 illustrates an example of a portion of transmitter which implements dither on the input of a digital-to-analog converter of the transmitter, in accordance with various examples.

FIG. 2 shows a block diagram of a dither signal generation circuit, in accordance with various examples.

FIG. 3 shows spreading codes and a code sequence, in accordance with various examples.

FIG. 4 illustrates the generation of a dither signal using a filter within the dither signal generation circuit of FIG. 2 and the various examples associated therewith.

FIG. 5 shows a table of dither signal waveforms, in accordance with various examples.

FIG. 6 shows a block diagram of a dither signal generation circuit, in accordance with various examples.

FIGS. 7A and 7B show frequency spectrum graphs, in accordance with various examples.

FIG. 8 illustrates a flow chart for a method of applying a dither signal waveform to a signal, in accordance with various examples.

FIG. 9 shows a block diagram of an example of a wireless base station that includes any of the dither signal generation circuits described herein.

### DETAILED DESCRIPTION

The following detailed description is presented for purposes of illustration and not of limitation. Benefits, advantages, and/or solutions to problems may be described with reference to various examples. The detailed description makes use of the various examples and refers to the accompanying drawings which illustrate the various examples described herein. The drawings, descriptions, and examples are described in sufficient detail to practice the disclosure. It is understood that connecting lines shown in the various drawings are intended to represent example functional relationships and/or physical couplings between various elements, but that other relationships and/or couplings are possible while remaining within the scope of the present disclosure. It will further be appreciated that the various drawings may not be drawn to scale in order to simplify and clarify the detailed description herein. Furthermore, it is understood that the descriptions and examples contained herein may permit the practice of other examples using logical, chemical, and/or mechanical changes without departing from the spirit and scope of this disclosure. For example, the steps recited in method and process descriptions may be executed in a different order, additional process steps may be added, and/or process steps may be removed while remaining within the scope of the present disclosure.

Any reference to singular items and/or examples includes plural items and/or examples and any reference to more than one item and/or example may include a singular item and/or example. Similarly, references to “a”, “an”, or “the” may include one or more of the referenced items, unless stated otherwise. Any reference to connected, coupled, fixed, attached, or the similar words and/or phrases may include partial, full, temporary, removable, permanent, or the other connection options. Any reference to contact, or similar phrase, may include minimal contact or reduced contact. All ranges used herein may include both the upper and lower values of the ranges, including ratio limits, that are disclosed herein. Stated values may include at least the variation that is expected within the field in which the present disclosure is practiced and as would be understood and accepted to include values that are within 10% of a stated value. Similarly, the use of “approximately”, “about”, “substantially” or other similar term represents an amount that is close to the stated value and that may still achieve the stated, or desired, result and/or perform the stated, or desired, function and may refer to an amount that is within 10% of the stated value.

The accompanying drawings, and detailed description of the drawings, include reference numerals that may be repeated across multiple examples. The repetition of reference numerals is intended for simplicity and clarity of description and is not intended to form or dictate a relationship between different examples described herein. The examples and descriptions provided herein are intended to be illustrative and not limiting beyond the scope of the claims.

The terms “couple” and “connect” are used throughout the specification. The terms may cover connections, communications, or signal paths that enable a functional relationship consistent with the description of the present disclosure. For example, if device A generates a signal to control device B to perform an action, in a first example device A is coupled (or connected) to device B, or in a second example device A is coupled (or connected) to device B through intervening component C if intervening component C does not substantially alter the functional relationship between device A and device B such that device B is controlled by device A via the control signal generated by device A.

The field of wireless communication has seen tremendous growth in recent years, driven by increasing demand for high-speed data transfer and low latency. To meet these demands, modern transceivers employ digital-to-analog converters (DACs) that operate at extremely high sampling rates, such as 12 gigasamples per second (GSPS). Dither signal generation circuits may be used to introduce a dither signal having an out-of-band signal to the input of the high-speed DAC to reduce spurious components produced by the DAC. A dither signal is a randomized noise that is added before digital-to-analog conversion to reduce bit-depth or quantization. However, the high-speed DACs introduce challenges in designing dither signal generation circuits that can produce out-of-band noise with stringent in-band leakage requirements. Generating out-of-band noise for radio frequency (RF) sampling DACs is particularly challenging due to the filtering complexity required to meet these stringent requirements. The filtered random noise has a high peak-to-average power ratio (PAR), which necessitates very high peak amplitudes for effective dither performance. This, in turn, reduces the available dynamic range of the DAC.

Disclosed herein are systems and methods for providing a dither signal generation circuit for use with RF sampling DACS that mitigate the effects of transmitter analog front-end nonlinearity. In various examples, the systems disclosed herein provide a low-complexity architecture for dither signal generation. In some examples, a sequence controller randomly selects between multiple different-length spreading sequences to generate a random bit sequence (e.g., a noise sequence). The random bit sequence may then be processed by a filter (e.g., an interpolation filter) to generate a waveform that is output as the dither signal. As such, the dither signal may vary over time and be represented as a waveform. Accordingly, the terms dither signal and waveform may be used interchangeably to refer to the time-varying signal produced by the dither signal generation circuit. In various examples, the dither signal generation circuit may use a variable clock rate to break periodicities and suppress strong spurs produced by the analog front-end nonlinearity in the presence of the dithered signal (e.g., the dithered squared signal).

In various examples, the system may further include a noise generation circuit and a spreading sequence circuit. As described herein, the interpolation filter length may be selected such that the output waveform (e.g., dither signal) depends on the current and previous outputs of the noise generation circuit and the spreading sequence sub-circuit. In some examples, the spreading sequence circuit may include multiple spreading sequence sub-circuits using spreading codes of different lengths. In other examples, the waveforms corresponding to the different spreading codes may be predetermined and stored in a waveform storage device (e.g., using one or more look-up tables). The spreading sequence circuit may randomly select a value representing a spreading code that the sequence controller uses to select a waveform. In such examples, the sequence controller may send a waveform index to the waveform storage circuit that is configured to output the waveform (e.g., dither signal) identified by the waveform index. As described herein, and in various examples, the waveforms present in the waveform storage circuit may be based on multiple spreading code sequences having different lengths.

Accordingly, the systems and methods disclosed herein offer several benefits. In various examples, they reduce the periodicities of the dither signal and thus the level of signal spurs (e.g., spurious emissions) caused by nonlinearity of the analog frontend, thereby improving dither performance and reducing the impact of TX analog front-end nonlinearity on system performance. Additionally, in various examples, these systems and methods result in a reduction of area and power consumption. While examples consistent with the present disclosure may provide these and other beneficial effects, no particular result is a requirement unless explicitly recited in a particular claim. Modifications are possible in the described embodiments, and other embodiments are possible, within the scope of the claims.

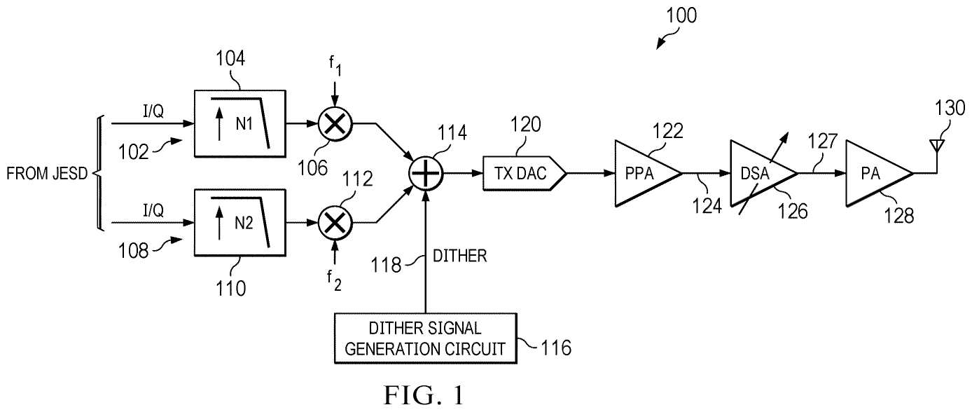

Referring now to FIG. 1, a transmitter 100 including a dual band upconverter is shown, in accordance with various aspects of the present disclosure. In various examples, transmitter 100 may form part of an RF device or equipment, such as a wireless base station. In some examples, the wireless base station transmitter may include a single band digital upconverter or a multi-band digital upconverter. While transmitter 100 includes a dual band upconverter, the principles described herein are also applicable to a single-band digital upconverter. In this example, transmitter 100 supports two frequency bands, a first upconverter 102 that processes a complex baseband signal stream including in-phase (I) and quadrature (Q) components corresponding to the first frequency band, and a second upconverter 108 that processes a complex baseband signal stream including I and Q components corresponding to the second frequency band. First upconverter 102 includes a first interpolation filter 104 and a first mixer 106 that convert the complex baseband signal of first frequency band to a real passband signal (e.g., a digital RF signal). Similarly, second upconverter 108 includes a second interpolation filter 110 and a second mixer 112 that convert the complex baseband signal of the second frequency band to a real passband signal (e.g., a digital RF signal). In various examples, a data interface may provide the inputs to the first and second interpolation filters 104 and 110. In some examples, the data interface may be a serial interface. In other examples, the data interface may be a JESD bus (Joint Electron Device Engineering Council (JEDEC) Solid-State Device (JESD)).

Transmitter 100 further includes an adder 114, a radio frequency (RF) digital-to-analog converter (DAC) 120, a pre-power amplifier (PPA) 122, a digital step attenuator (DSA) 126, a power amplifier (PA) 128, and an antenna 130. Adder 114 receives the signals output by first and second mixers 106 and 112 as inputs and outputs a combined signal (e.g., a digital signal) to RF DAC 120. RF DAC 120 converts the received digital signal to an analog signal output. PPA 122 receives the analog signal as an input and outputs an amplified output signal 124. DSA 126 receives output signal 124 as an input and outputs an amplitude adjusted signal 127. The DSA 126 modifies the amplitude of the output signal 124 to provide the amplitude adjusted signal 127 that compensates for gain variations in the power amplifier 128 to thereby maintain a steady power output from the power amplifier 128. In various examples, the amplitude adjusted signal 127 may suffer from spurious emissions due to the non-linearity inherent in RF DAC 120, PPA 122, and/or DSA 126.

In that regard, transmitter 100 further includes a dither signal generation circuit 116 that generates a dither signal 118. Adder 114 further receives the dither signal 118 as an input and combines dither signal 118 with the signals output by first and second mixers 106 and 112. RF DAC 120 receives this signal as an input, as described above. The addition of dither signal 118 at the input of RF DAC 120 is effective in mitigating spurious emissions on the output analog signal. In various examples, the RF DAC 120 may comprise a set of thermometric elements and a set of binary-weighted elements. The thermometric and binary-weighted elements include current sources. Adding the dither signal 118 to the input of RF DAC 120 decreases the negative effects of nonidealities such as mismatches in the thermometric and binary-weighted elements, improving the output.

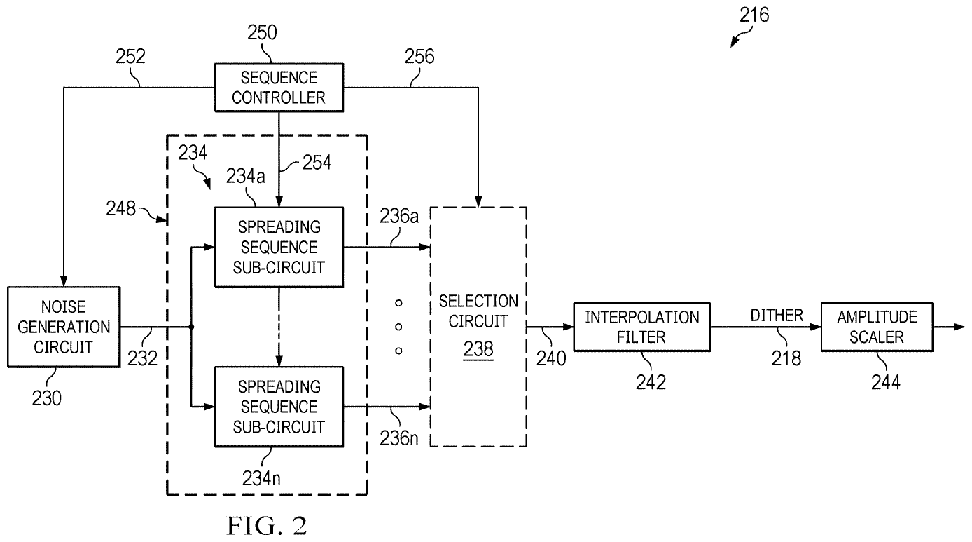

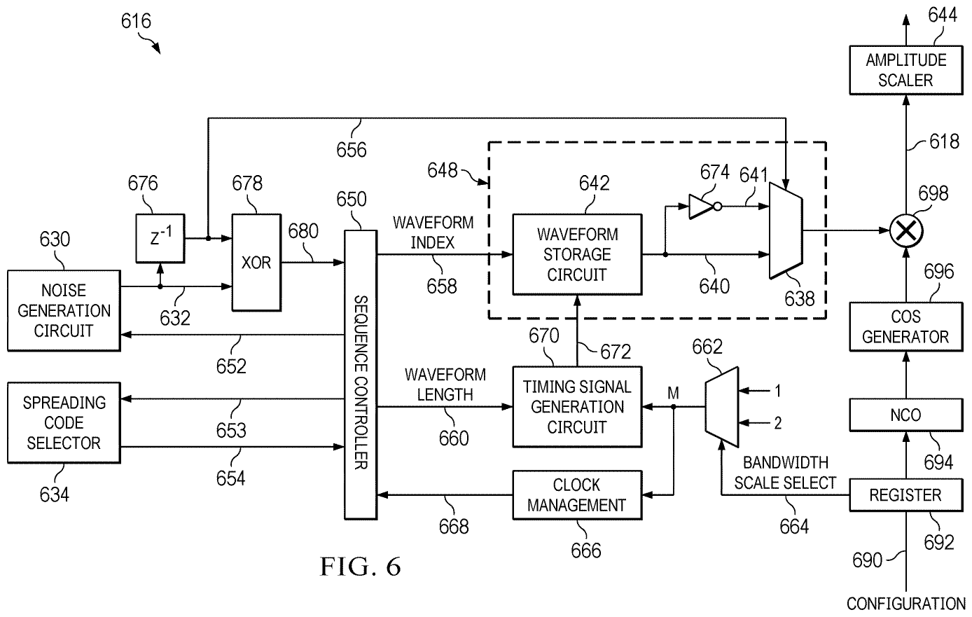

For the dither to be effective, the amplitude of dither signal 118 should be larger (e.g., 2-4×) than the largest current source of RF DAC 120. Additionally, the dither signal 118 should have a low peak-to-average power ratio (PAR) so as not use up too much of the dynamic range of the RF DAC 120. Furthermore, the generation and addition of dither signal 118 via adder 114 may occur at the sampling rate of RF DAC 120 (e.g., 12 gigasamples per second, GSPS). As described in further detail below, the thermal load of dither signal generation circuit 116 may be reduced using one or more of the examples disclosed herein (e.g., FIG. 2 and FIG. 6).

Referring now to FIG. 2, a dither signal generation circuit 216 is shown, in accordance with various aspects of the present disclosure. In some examples, dither signal generation circuit 216 may be an example of dither signal generation circuit 116 in FIG. 1. In some examples, the transmitter circuit may be used in a wireless base station, a Wi-Fi system, a Bluetooth low energy (BLE) system, RADAR systems, satellite communications, or a cellular system (e.g., 5G, 6G), among others. In the example of FIG. 2, dither signal generation circuit 216 includes a noise generation circuit 230, a set of spreading sequence sub-circuits (e.g., 234a through 234n), an interpolation filter 242, an amplitude scaler 244, and a sequence controller 250. In some examples, dither signal generation circuit 216 may optionally include selection circuit 238. As shown, dither signal generation circuit 216 may include more than one spreading sequence sub-circuit. For example, dither signal generation circuit 216 may include a first spreading sequence sub-circuit 234a and at least one additional second spreading sequence sub-circuit 234n. In other words, the ellipses shown in FIG. 2 between the first spreading sequence sub-circuit 234a and the second spreading sequence sub-circuit 234n indicates that any number of additional spreading sequence sub-circuits may be provided and not necessarily a particular ordering or physical arrangement between the two or more spreading sequence sub-circuits. As such, the set of spreading sequence sub-circuits such as first spreading sequence sub-circuit 234a to second spreading sequence sub-circuit 234n may be collectively referred to as spreading sequence sub-circuits 234. First spreading sequence sub-circuit 234a and second spreading sequence sub-circuit 234n may also collectively be referred to as a spreading sequence circuit 248.

Noise generation circuit 230 may be a digital noise generation circuit that outputs a random, or pseudo random, sequence of “1's” and “0's” (also referred to as “+1's” and “−1's”, respectively, herein). In some examples, noise generation circuit 230 may output the pseudo-random bit sequence 232 at a same bit rate to each of the spreading sequence sub-circuits 234. In other examples, noise generation circuit 230 may output the pseudo-random bit sequence 232 at different bit rates (e.g., the first bit rate and a second bit rate) to each of the spreading sequence sub-circuits 234. In various examples, the different bit rates of the pseudo-random bit sequence 232 may be based on the length of the spreading code used by the spreading sequence sub-circuits 234 (as described in further detail below). For example, noise generation circuit 230 may generate a first pseudo-random bit to first spreading sequence sub-circuit 234a at a first rate corresponding to the length of a first spreading code of first spreading sequence sub-circuit 234a, and generate a next, second pseudo-random bit to second spreading sequence sub-circuit 234n at a second rate corresponding to the length a spreading code of second spreading sequence sub-circuit 234n. In some examples, noise generation circuit 230 may include a linear feedback shift register (LFSR) noise generation circuit. In other examples, noise generation circuit 230 may include other types of random or pseudo random number generators.

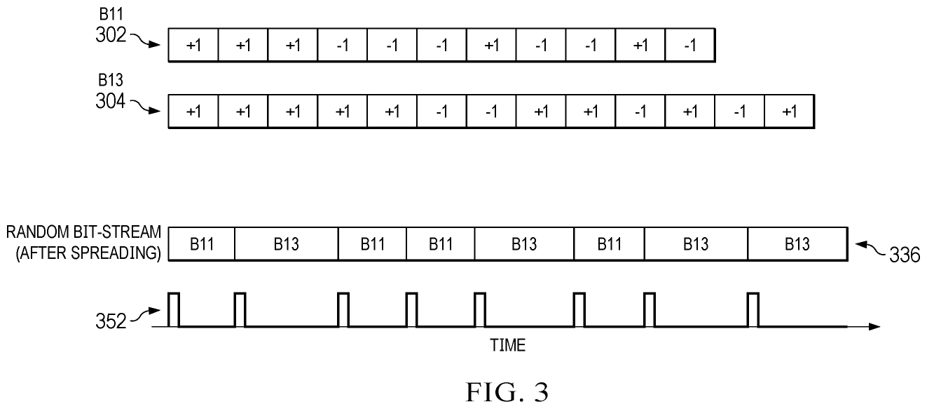

The spreading sequence sub-circuits 234 may include two, three, or more spreading sequence sub-circuits 234. For ease of discussion, FIG. 2 includes first spreading sequence sub-circuit 234a and second spreading sequence sub-circuit 234n. In various examples, dither signal generation circuit 216 may include one or more additional spreading sequence sub-circuits. Each of the spreading sequence sub-circuits 234 may use any suitable spreading code. In various examples, each spreading sequence sub-circuit 234 may use a respective, different spreading code. In some examples, a single spreading sequence sub-circuit may use two or more different spreading codes. In one example, the first spreading sequence sub-circuit 234a may use the Barker-11 spreading code. In another example the second spreading sequence sub-circuit 234n may use the Barker-13 spreading code. In other examples, additional spreading sequence sub-circuits 234 may use a 7-bit spreading code, a 10-bit spreading code, or another suitable spreading code. The spreading sequence sub-circuits 234 may each use a different spreading code. In that regard, each of the spreading codes may have a different length, as described in FIG. 3.

Referring momentarily to FIG. 3, a first spreading code 302 (e.g., the Barker-11 spreading code) and a second spreading code 304 (e.g., the Barker-13 spreading code) are shown, in accordance with various aspects of the present disclosure and the example of FIG. 2. First spreading code 302 has a first length (L₁) of 11 bits (L=11) and second spreading code 304 has a second length (L₂) of 13 bits (L=13). For each +1 output bit (e.g., “1”) from the noise generation circuit 230, the first spreading sequence sub-circuit 234a outputs an 11-bit sequence: [+1, +1, +1, −1, −1, −1, +1, −1, −1, +1, −1], according to the first spreading code 302. For each −1 output bit (e.g., “0”) from the noise generation circuit 230, the first spreading sequence sub-circuit 234a outputs an 11-bit sequence having the opposite polarity (e.g., an inverse sequence): [−1, −1, −1, +1, +1, +1, −1, +1, +1, −1, +1], according to the first spreading code 302. Similarly, for each +1 output bit (e.g., “1”) from the noise generation circuit 230, the second spreading sequence sub-circuit 234n outputs a 13-bit sequence: [+1, +1, +1, +1, +1, −1, −1, +1, +1, −1, +1, −1, +1], according to the second spreading code 304. For each −1 output bit (e.g., “0”) from the noise generation circuit 230, the second spreading sequence sub-circuit 234n outputs a 13-bit sequence having the opposite polarity (e.g., an inverse sequence): [−1, −1, −1, −1, −1, +1, +1, −1, −1, +1, −1, +1, −1], according to the second spreading code 304. As used herein, having the opposite polarity means replacing each +1 with a −1 and vice versa. Accordingly, the first spreading sequence sub-circuit 234a and the second spreading sequence sub-circuit 234n may use either of the first spreading code 302 or second spreading code 304, or another spreading code.

In various examples, a cost function may be used to determine a set of spreading codes to use by spreading sequence sub-circuits 234. In various examples, the cost function may be a weighted cost function. In some examples, the weighted cost function may be represented by Function 1.

J=W₁*Peak_PSD_{dither,dBFS}+W₂*Peak_PSD_{dither}²_{,dBFS}+W₃*PAR_{dither,dB}+W₄*dither_peak_to_k^{th}_percentile_{dB} Function 1

The cost function in Function 1 weights the various considerations for determining a spreading code of spreading sequence sub-circuits 234. The Peak_PSD_{dither,dBFS} value is the Peak Power Spectral Density (PSD) of the out-of-band dither signal (in dBFS). The PSD indicates the spectral distribution of the wideband dither signal. The Peak_PSD_{dither}²_{,dBFS} value is the Peak Power Spectral Density of the dither squared signal (in dBFS) mixed with signal of interest (transmitted signal). This metric represents the strength of unwanted spurious emissions within the band-of-interest. The PAR_{dither,dB} value is the Peak to Average Power ratio (PAR) of the out-of-band dither signal (in dB). To effectively mitigate the DAC element mismatches, dither signal needs to have higher amplitude but lower PAR so as to not eat into the available dynamic range of the DAC. The dither_peak_to_k^{th}_percentile_{dB} value is the peak to kth percentile ratio of the out-of-band dither signal (in dB). The Kth percentile represents a level such that the signal stays below it for k% of the time. Peak-to-kth percentile is the difference between signal peak and this level. This difference should ideally be low to ensure that signal stays in higher amplitude region for larger portion of the time.

Weights W₁, W₂, W₃, & W₄ can be selected based on relative importance of the above performance metrics and cross correlation between these metrics. The different weights may be based on design and use considerations. Additionally, the weights may be different based on the analog circuitry being used. Accordingly, a weighted cost function may be used to select the two or more different spreading codes to be used. The set of spreading sequence sub-circuits 234 may then be determined by using the identified set of spreading codes.

Returning to FIG. 2, the first spreading sequence sub-circuit 234a receives pseudo-random bit sequence 232 as input and outputs a first random bit-sequence 236a and the second spreading sequence sub-circuit 234n receives pseudo-random bit sequence 232 as input and outputs a second random bit-sequence 236n. As will be described below, in various examples, sequence controller 250 may randomly select one of the set of spreading sequence sub-circuits 234 to spread the pseudo-random bit sequence 232. Accordingly, noise generation circuit 230 may generate the pseudo-random bit sequence at a rate corresponding to the length of the spreading code of the selected spreading sequence sub-circuit 234. This may effectively cause the pseudo-random bit sequence 232 to have a bit rate of Fdac/(L*N), where Fdac is the sampling rate provided to the input of a DAC (e.g., RF DAC 120), L is the spreading code length (e.g., 11 bits, 13 bits, etc.) of the selected spreading sequence sub-circuit (e.g., first spreading sequence sub-circuit 234a, second spreading sequence sub-circuit 234n, etc.), and N is the upsampling factor used by the interpolation filter 242.

For example, when the first spreading sequence sub-circuit 234a uses the Barker-11 spreading code (e.g., first spreading code 302), the pseudo-random bit sequence 232 has a first bit rate of Fdac/(Lₐ*N), where Lₐ is 11. As another example, when the second spreading sequence sub-circuit 234n uses the Barker-13 spreading code (e.g., second spreading code 304), the pseudo-random bit sequence 232 has a second bit rate of Fdac/(Lₙ*N), where Lₙ is 13. Accordingly, the bit rate of the pseudo-random bit sequence 232 for each of the spreading sequence sub-circuits 234 may be different. In some examples, the first and second bit rates may refer to an instantaneous bit-rate across time (e.g., not as parallel bit rates).

Regardless of the bit rate of pseudo-random bit sequence 232, the output of the spreading sequence sub-circuits 234 is Fdac/N. By mapping each pseudo-random bit (e.g., pseudo-random bit sequence 232) from the noise generation circuit 230 to L bits of the corresponding spreading code, the bit rate of the random bit-sequence 236 output by each of the spreading sequence sub-circuits 234 is the same, Fdac/N. For example, the first random bit-sequence 236a and second random bit-sequence 236n may both have the same bit rate of Fdac/N. In other words, regardless of the bit rate at which each of the spreading sequence sub-circuits 234 receive the pseudo-random bit sequence 232, the output bit rate of the random bit-sequences 236 is determined by the sampling rate (Fdac) of the DAC (e.g., RF DAC 120) and the upsampling factor (N), resulting in the identical output bit rate of Fdac/N for all of the spreading sequence sub-circuits 234. Accordingly, the difference in length of the different spreading sequence sub-circuits 234 may be compensated for by varying the input bit rate, such that the output of each spreading sequence sub-circuit 234 has the same bit rate.

In some examples, dither signal generation circuit 216 may include an optional selection circuit 238, as shown in FIG. 2. Selection circuit 238 (optional) receives first random bit-sequence 236a and second random bit-sequence 236n as inputs and a selector signal 256 as a control signal. In various examples, selection circuit 238 may be implemented as a multiplexer circuit (e.g., digital logic gates). For example, when the selector signal 256 has a first value, the selection circuit 238 outputs the first random bit-sequence 236a as the selected random bit-sequence 240. Conversely, when the selector signal 256 has a second value, the selection circuit 238 outputs the second random bit-sequence 236n as the selected random bit-sequence 240.

Sequence controller 250 provides command and control signals to the noise generation circuit 230, the spreading sequence sub-circuits 234, and the selection circuit 238. For example, sequence controller 250 may provide a LFSR update signal 252, a spreading code signal 254, and a selector signal 256. Noise generation circuit 230 may receive the LFSR update signal 252, the spreading sequence sub-circuits 234 may receive spreading code signal 254, and selection circuit 238 may receive selector signal 256. In various examples, noise generation circuit 230 outputs pseudo-random bit sequence 232 in response to a LFSR update signal 252, thus affecting the bit rates of pseud-random bit sequences 232. In some examples, first spreading sequence sub-circuit 234a and second spreading sequence sub-circuit 234n output first random bit-sequence 236a and second random bit-sequence 236n, respectively, in response to receiving spreading code signal 254. For example, first spreading sequence sub-circuit 234a may spread pseudo-random bit sequence 232 using first spreading code 302 to output first random bit-sequence 236a, and second spreading sequence sub-circuit 234n may spread pseudo-random bit sequence 232 using second spreading code 304 to output second random bit-sequence 236n, respectively, in response to spreading code signal 254.

In that regard, sequence controller 250 may randomly choose to enable one of the spreading sequence sub-circuits 234 via spreading code signal 254 and/or selector signal 256. As described above, the spreading code length used by each of the spreading sequence sub-circuits 234 may be different. Therefore, sequence controller 250 may adjust the timing of LFSR update signal 252 so that noise generation circuit 230 updates pseudo-random bit sequence 232 at the appropriate time (e.g., the first or second bit rate). For example, if first spreading sequence sub-circuit 234a has a spreading code length of 11 and is chosen, then 11 bits (e.g., 11 clock cycles) will be output on first random bit-sequence 236a. Therefore, LFSR update signal 252 triggers after 11 clock cycles. However, if second spreading sequence sub-circuit 234n has a spreading code length of 13, triggering LFSR update signal 252 after 11 clock cycles causes noise generation circuit 230 to updated pseudo-random bit sequence 232 before second spreading sequence sub-circuit 234n has completed outputting second random bit-sequence 236n. Accordingly, LFSR update signal 252 triggers LFSR update signal 252 after the appropriate time based on which of the spreading sequence sub-circuits 234 is selected.

Referring back to FIG. 3, a random-bit sequence 336 and a LFSR update signal 352 are shown, in accordance with various aspects of the present disclosure. The random-bit sequence 336 shows a random selection of the first spreading code 302 (B11) and the second spreading code 304 (B13). The LFSR update signal 352 shows the pulses output by sequence controller 250 cause noise generation circuit 230 to generate a next random sequence, based on which one of the first spreading code 302 and the second spreading code 304 is selected at any given time. As can be seen, the random selection of first spreading code 302 or second spreading code 304 removes the periodicity of the LFSR update signal 352 that can propagate through the system and may cause unwanted signals (e.g., spurious emissions) in an analog signal.

Returning to FIG. 2, sequence controller 250 may control randomizing the spreading sequences. In some examples, sequence controller 250 may randomly select one of the spreading sequence sub-circuits 234 and provide the LFSR update signal 252, the spreading code signal 254, and the selector signal 256 based on the random selection. For example, as shown in FIG. 3, sequence controller 250 first selects the first spreading code 302 and sends the LFSR update signal 252 to the noise generation circuit 230 and the spreading code signal 254 and the selector signal 256 based on the selection of the first spreading code 302. The first spreading sequence sub-circuit 234a uses the first spreading code 302 to spread the pseudo-random bit sequence 232 for 11 clock cycles (e.g., Lₐ=11 for Barker-11 code) to generate the first random bit-sequence 236a. Next, the sequence controller 250 selects the second spreading code 304 and sends the LFSR update signal 252 to noise generation circuit 230 and the spreading code signal 254 and selector signal 256 based on the selection of the second spreading code 304. The second spreading sequence sub-circuit 234n uses the second spreading code 304 to spread the pseudo-random bit sequence 232 for 13 clock cycles (e.g., Lₙ=13 for Barker-13 code) to generate the second random bit-sequence 236n. Next, the sequence controller 250 consecutively selects the first spreading code 302, then switches to the second spreading code 304, and so on. The sequence controller 250 randomly switches between the first spreading sequence sub-circuit 234a and the second spreading sequence sub-circuit 234n to spread the pseudo-random bit sequence 232 and generate the random bit-sequences 236. This continues in a random fashion to generate the selected random bit-sequence 240 that is input into the interpolation filter 242. The interpolation filter 242 upsamples and filters the selected random bit-sequence 240 (e.g., first random bit-sequence 236a, second random bit-sequence 236n, etc.) to generate the dither signal 218 during this process.

The interpolation filter 242 upsamples and filters the selected random bit-sequence 240 provided by the structured random bit-sequences 236 (or optionally the selection circuit 238). The interpolation filter 242 upsamples the selected random bit-sequence 240 by an upsample ratio of N. In one example, N is 32. By upsampling the selected random bit-sequence 240 by a factor N, the dither signal 218 output by the interpolation filter 242 has a sampling rate of Fdac and can be amplitude scaled (via amplitude scaler 244) and added to the input of RF DAC 120 via adder 114, as described above in FIG. 1.

In various examples, the interpolation filter 242 may be implemented as an N*L+1 tap fixed-coefficient finite impulse response (FIR) filter. In one example, when N=32 and L=11 (e.g., using the first spreading code 302) the interpolation filter 242 is a 353-tap fixed-coefficient FIR filter. In this example, the dither signal 218 output by the interpolation filter 242 during each time window depends on, at most, the current output bit and the previous output bit of the noise generation circuit 230. Because no time window can be less than 11 bits, the dither signal 218 does not include any outputs from before the previous output bit. In another example, when N=32 and L=13 (e.g., using the second spreading code 304) the interpolation filter 242 is a 417-tap fixed-coefficient FIR filter. In this example, the dither signal 218 output by the interpolation filter 242 during each time window may depend on the current output bit and up to two previous output bits of the noise generation circuit 230. Because the first spreading code 302 (e.g., 11 bit) may be used two or more times in a row, it is possible that the interpolation filter 242 spans the time window of the two previous output bits and the current output bit.

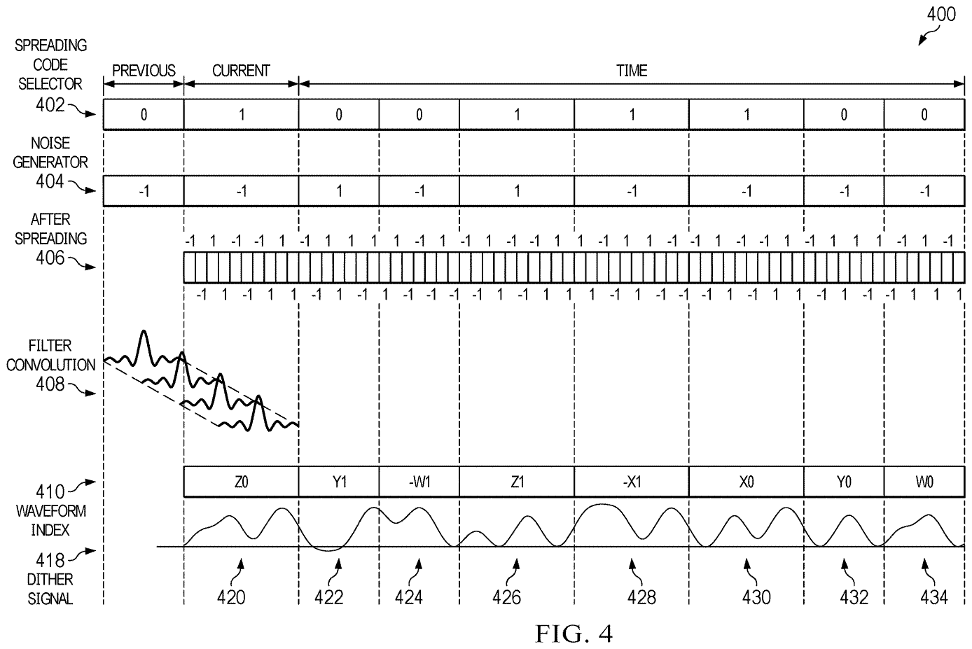

In various examples, as described in further detail below, the complexity of the waveform generation circuitry may be reduced by reducing the number of possible waveforms that may be generated by interpolation filter 242 (e.g., the dither signal 218) so that the waveforms may be deterministically provided based on the current random bit and the previous random bit. Therefore, it is advantageous both in terms of size and power consumed to limit the length of the interpolation filter 242 to be equal to the length of the shortest spreading sequence code that is used (e.g., the shortest one of the spreading sequence codes determined according to Function 1). In this example, that is the first spreading code 302 having a length of 11 bits. In so doing, it is ensured that the window of the interpolation filter 242 relies on the current and the previous noise and spreading code bits, and no other bits, as further described in FIG. 4.

Accordingly, the systems and methods disclosed herein may be used to improve the quality of a transmitted signal. In various examples, a sequence controller may be connected to a noise generation circuit and two or more sequence code generators. In some examples, the sequence controller may trigger the noise generation circuit to generate a random bit. The sequence code generators may spread the random bit using a sequence code. In some examples, the sequence controller may randomly select which sequence code generator provides the output noise signal. The output noise signal may then be processed by an interpolation filter to generate a dither signal (e.g., waveform) for use by a DAC.

Referring now to FIG. 4, a chart 400 of an example dither signal (e.g., waveform) generated based on random noise bits and spreading code selector bits is shown, in accordance with various aspects of the present disclosure. Chart 400 includes spreading code selector bits 402, noise generation circuit output bits 404, and a dither signal 418 generated based on the spreading code selector bits 402, the noise generation circuit output bits 404, and a filter (e.g., interpolation filter 242). The example sequence of spreading code selections from sequence controller 250 includes: [0, 1, 0, 0, 1, 1, 1, 0, 0]. The example sequence of pseudo-random bits from the noise generation circuit 230 includes: [−1, −1, 1, −1, 1, −1, −1, −1, −1]. FIG. 4 includes a first spreading code and a second spreading code. The first spreading code has a first length L₁ of 7 bits and the sequence: [−1, −1, 1, 1, 1, −1, 1]. The second spreading code has a second length L₂ of 10 bits and the sequence: [−1, −1, 1, 1, −1, −1, −1, 1, 1, 1]. The spreading code selector bit 402 of “0” corresponds to the first spreading code and the spreading code selector bit 402 of “1” corresponds to the second spreading code. Accordingly, the dither signal 418 (e.g., waveform) may be generated using a filter convolution 408 based on the spreading code selector bit 402, the noise generation circuit output bit 404, and the selected spreading codes, as described in further detail below. In various examples, the filter convolution 408 may be performed on an upsampled spreading sequence signal.

Each noise generation circuit output bit 404 from the noise generation circuit 230 maps to the selected spreading code (either 7-bit or 10-bit) as illustrated shown as after spreading 406. For example, a first spreading sequence sub-circuit (e.g., first spreading sequence sub-circuit 234 a) may use the 7-bit sequence and a second spreading sequence sub-circuit (second spreading sequence sub-circuit 234n) may use the 10-bit sequence. As described above in FIG. 3, the output of the first spreading sequence sub-circuit 234a is the 7-bit sequence ([−1, −1, 1, 1, 1, −1, 1]) when the noise generation circuit output bits 404 is “1” and is the inverse (e.g., a negation) of the 7-bit sequence ([1, 1, −1, −1, −1, 1, −1]) when the noise generation circuit output bits 404 is “0”. Similarly, the output of the second spreading code 234n generator is the 10-bit sequence ([−1, −1, 1, 1, −1, −1, −1, 1, 1, 1]) when the noise generation circuit output bits 404 is “1” and is the inverse (e.g., a negation) of the 10-bit sequence ([1, 1, −1, −1, 1, 1, 1, −1, −1, −1]) when the noise generation circuit output bits 404 is “0”.

FIG. 4 illustrates the filter convolution 408 performed by the interpolation filter 242, which results in the output dither signal 418 (e.g., waveform). The length of the filter convolution 408 corresponds to the least of the lengths of the selected spreading code sequences multiplied by the upsample factor N. In this example, the length of the filter convolution 408 is 7*32+1 (e.g., L*N+1) because 7 is the least length of the first spreading code (e.g., 7-bits) and the second spreading code (e.g., 10-bits). As described above, the 7-bit length restricts the filter convolution 408 to the current and previous spreading code selector bits 402 and noise generation circuit output bits 404.

The dither signal 418 is illustrated across time windows 420, 422, 424, 426, 428, 430, 432, and 434. The dither signal 418 (e.g., waveform) within each time window 420-434 is given a waveform index 410 (e.g., Z0, Y1, −W1, Z1, −X1, X0, Y0, and W0 in FIG. 4). Each waveform is the result of the filter convolution 408 applied to the output of the selected spreading code that is based on the selected noise bit. Each waveform index 410 refers to a specific combination of spreading code selector bits 402 and noise generation circuit output bits 404. FIG. 4 shows a subset of possible waveform indexes 410 (e.g., 8 waveform indexes).

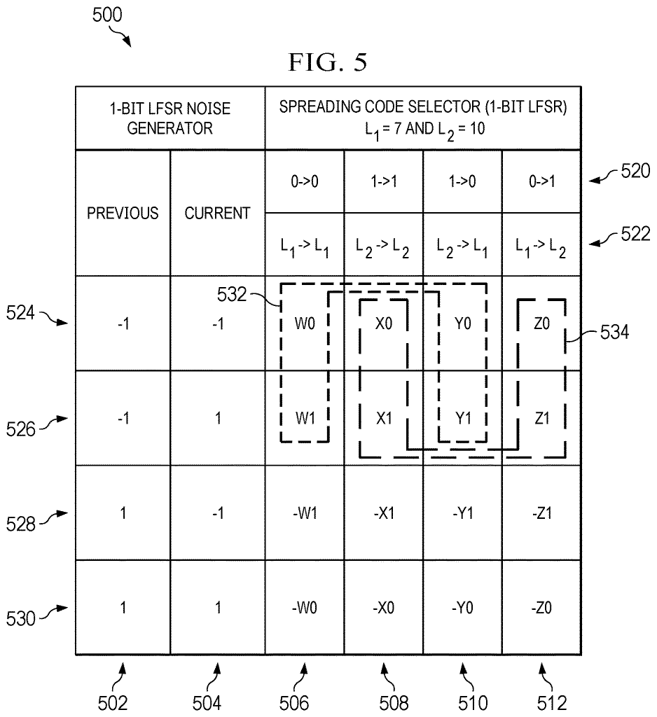

In that regard, FIG. 5 shows a table 500 illustrating the 16 possible waveforms that may be produced by a convolution filter (e.g., interpolation filter 242) based on two spreading sequence sub-circuits (e.g., the spreading sequence sub-circuits 234), the previous and current values of both the spreading code selector bits, and the random noise bits. Table 500 includes columns 502, 504, 506, 508, 510, and 512, and rows 520, 522, 524, 526, 528, and 530. Columns 502 and 504 show the possible combinations of the previous and current random noise bits with column 502 showing the previous random noise bit and column 504 showing the current random noise bit. Columns 506-512 show the possible combinations of the previous and current spreading code selector bits and the waveforms generated by the combination of the previous and current random noise bit and the spreading codes selected by the previous and current spreading selector code bit after being passed through a filter (e.g., filter convolution 408, interpolation filter 242).

For example, as shown in column 506, when the previous and current values of the spreading code selector are both “0” (e.g., spreading length L₁ to spreading length L₁), the output waveform is one of W0, W1, −W1, −W0 based on the previous and current random noise bits of columns 502 and 504. As shown in column 508, when the previous and current values of the spreading code selector are both “1” (e.g., spreading length L₂ to spreading length L₂), the output waveform is one of X0, X1, −X1, −X0 based on the previous and current random noise bits of columns 502 and 504. As shown in column 510, when the previous and current values of the spreading code selector change from “1” to “0” (e.g., spreading length L₂ to spreading length L₁), the output waveform is one of Y0, Y1, −Y1, −Y0 based on the previous and current random noise bits of columns 502 and 504. As shown in column 512, when the previous and current values of the spreading code selector change from “0” to “1” (e.g., spreading length L₁ to spreading length L₂), the output waveform is one of Z0, Z1, −Z1, −Z0 based on the previous and current random noise bits of columns 502 and 504. This deterministic behavior enables the hardcoding of the 16 waveforms into a circuit so that a waveform can be selected from the 16 predetermined waveforms and output as the dither signal 418 based the previous and current values of the random noise bits and the code selector bits. In so doing, the spreading sequence sub-circuits and interpolation filter may be replaced by a waveform storage circuit, as described in further detail below.

The number of hardcoded waveforms may be reduced (or simplified) further by identifying that half of the waveforms are an inverse (e.g., a 2's complement negation) of the other half of the waveforms. This reduces the number hardcoded by half so that the 16 waveforms can be produced using 8 hardcoded waveforms. In that regard, two sets of waveforms are selected, namely a first set 532 and a second set 534. The first set 532 of waveforms includes [W0, W1, Y0, Y1] and the second set 534 of waveforms includes [X0, X1, Z0, Z1]. Each of the waveforms in the first and second sets 532 and 534 can be inverted to produce the other 8 waveforms (e.g., −W0, −W1, −Y0, −Y1, −X0, −X1, −Z0, −Z1). Each waveform of the first set 532 of waveforms has a first length L₁*N (e.g., 7*32=224) when the first spreading code is the 7-bit code (see time windows 422, 424, 432, and 434 of FIG. 4). Each waveform of the second set 534 of waveforms has a second length L₂*N (e.g., 10*32=320) when the second spreading code is the 10-bit code (see time windows 420, 426, 428, and 430 of FIG. 4). As described below, when hardcoding the waveforms in a circuit (e.g., FIG. 6) the length of each waveform may be used for outputting the waveforms as the dither signal. Therefore, a system may be implemented to hard code the 8 waveforms of the first and second sets 532 and 534 of waveforms.

Referring now to FIG. 6, a dither signal generation circuit 616 is shown, in accordance with various aspects of the present disclosure. Dither signal generation circuit 616 includes similar components as dither signal generation circuit 216 in FIG. 2 including a dither signal 618, a noise generation circuit 630, a first selection circuit 638, an amplitude scaler 644, a sequence controller 650, a spreading sequence circuit 648, and a first LFSR update signal 652. Spreading sequence circuit 648 may include waveform storage circuit 642, first selection circuit 638, and inverted waveform signal 641. Dither signal generation circuit 616 further includes a spreading code selector 634, a, a waveform storage circuit 642, a bandwidth scale select signal 664, a clock management circuit 666, an timing signal generation circuit 670, an inverter 674, a delay element 676, a logic circuit 678, a register 692, a numerically-controlled oscillator (NCO) 694, a cosine (COS) generator 696, and a mixer 698. Dither signal generation circuit 616 takes advantage of the deterministic waveforms that can be generated and stored for later output. For example, as described in further detail below, the waveform storage circuit 642 may store the waveforms (e.g., the first and second sets 532 and 534) identified in table 500 of FIG. 5 and provide one of those waveforms, or the inverse of one of the waveforms, as the dither signal 618 in response one or more signals from the sequence controller 250.

Noise generation circuit 630 may be similar to noise generation circuit 230 described above in FIG. 2. For example, noise generation circuit 630 may provide a pseudo-random bit sequence 632 in response to a first LFSR update signal 652 from sequence controller 250.

Spreading code selector 634 may provide a spreading code signal 654 in response to a second LFSR update signal 653. In that regard, the spreading code signal 654 may be a value that represents a spreading code (e.g., first spreading code 302, second spreading code 304, etc.). In various examples, spreading code selector 634 be implemented as a random, pseudo random, number generator to select and provide a spreading code index (e.g., 0 or 1 when using two spreading codes).

Sequence controller 650 provides command and control signals to noise generation circuit 630, spreading code selector 634, waveform storage circuit 642, and timing signal generation circuit 670. For example, sequence controller 650 may provide first LFSR update signal 652, second LFSR update signal 653, a waveform index signal 658, and a waveform length indicator signal 660. Noise generation circuit 630 may output pseudo-random bit sequence 632 in response to first LFSR update signal 652 and spreading code selector 634 may output spreading code signal 654 in response to second LFSR update signal 653. In various examples, first LFSR update signal 652 and second LFSR update signal 653 may be the same signal. In various examples, sequence controller 650 may generate waveform index signal 658 and waveform length indicator signal 660 based on the previous and current spreading code signal 654 and the previous and current pseudo-random bit sequence 632. For example, waveform storage circuit 642 may provide a waveform signal 640 (e.g., a stored bit sequence) in response to waveform index signal 658. Moreover, timing signal generation circuit 670 may provide a timing signal 672 to waveform storage circuit 642 based on the waveform length indicator signal 660 provided by sequence controller 650 (as described in further detail below).

Logic circuit 678 and delay element 676 receive the pseudo-random bit sequence 632 and provide a comparison signal 680 and a selector signal 656, respectively. For example, delay element 676 receives the pseudo-random bit sequence 632, holds the value (e.g., for one clock cycle), and outputs selector signal 656. Logic circuit 678 receives the pseudo-random bit sequence 632 and the selector signal 656 as inputs and provides comparison signal 680 to sequence controller 650. In this configuration, the comparison signal 680 is based on the previous random bit (e.g., selector signal 656) and the current random bit (e.g., pseudo-random bit sequence 632). In some examples, the logic circuit 678 is an XOR gate, but can be other logic gates, or a combination of logic gates. In the example of the logic circuit 678 being an XOR gate, the comparison signal 680 is logic “0” when both the previous and current random bits are the same (e.g., both “+1” or “−1”) and logic “1” when both the previous and current random bits are different (e.g., “+1” and “−1”).

Sequence controller 650 generates waveform index signal 658 and waveform length indicator signal 660 based on the previous and the current output of both noise generation circuit 630 and spreading code selector 634. Accordingly, in some examples, sequence controller 650 may generate an output waveform index signal 658 or waveform length indicator signal 660 after sequence controller 650 has received two spreading code signals 654. For example, sequence controller 650 may store two values of the spreading code signal 654, the previous value and the current value.

In that regard, sequence controller 650 receives comparison signal 680 and spreading code signal 654 in response to first LFSR update signal 652 and second LFSR update signal 653, respectively. For example, sequence controller 650 receives a first comparison value and a first spreading code value in response to a first signal (e.g., second LFSR update signal 653) and receives a second comparison value and a second spreading code value in response to a second signal (e.g., second LFSR update signal 653). Sequence controller 650 may store the previous and current spreading code values for future use to determine which waveform index to send to waveform storage circuit 642. As described above in FIG. 5, the waveform index may be determined based on the previous and current spreading code values and the previous and current random bits. However, because the waveform storage circuit 642 stores half of the possible waveforms (e.g., first set 532 and second set 534), sequence controller 650 may select the waveform based on the previous and current spreading code values and the difference between the previous and current random bits, as provided by logic circuit 678.

In that regard, waveform storage circuit 642 outputs a waveform signal 640 in response to the waveform index signal 658 and the timing signal 672 from timing signal generation circuit 670. For example, the timing signal generation circuit 670 (described below) outputs a timing signal 672 to waveform storage circuit 642 to cause the samples of the stored waveforms implemented by the waveform storage circuit 642 to be output on each clock cycle as provided by timing signal 672 as waveform signal 640. The input of inverter 674 is connected to the waveform signal 640 and outputs an inverted waveform signal 641 (e.g., the 2's complement of the waveform signal 640). The first selection circuit 638 has a first input that receives the inverted waveform signal 641 and a second input that receives the waveform signal 640. First selection circuit 638 is controlled by selection circuit signal 656 from delay element 676. The first selection circuit 638 outputs the inverted waveform signal 641 as the dither signal 618 in response to the selector signal 656 being a first value (e.g., “1”) and outputs the waveform signal 640 as the dither signal 618 in response to the selector signal 656 being a second value (e.g., “0”).

Accordingly, sequence controller 650 determines the waveform to output based on the previous and current spreading code values and the comparison of the previous and current random bit values and the first selection circuit 638 outputs the selected waveform or its inverse based on the previous random bit value. Thus, the previous random bit (as provided by delay element 676) is used to select between waveform signal 640 and inverted waveform signal 641 to be output as the dither signal 618 of dither signal generation circuit 616. This relationship is shown in table 500 of FIG. 5 and waveform index 410 of FIG. 4.

Referring to FIG. 5, the first set 532 and second set 534 of waveforms that are stored into the waveform storage circuit 642 include those waveforms that are selected when the previous random bit is “0” (e.g., “−1”). Therefore, in the present example, when the selector signal 656 is “0” the dither signal 618 will be the waveform signal 640. Conversely, when the selector signal 656 is “1” the dither signal 618 will the inverted waveform signal 641 (e.g., the waveforms that are not coded into the waveform storage circuit 642). FIG. 4 shows this same relationship as the value of waveform index 410 is the waveform or the inverse waveform (e.g., negative) based on the previous value of the noise generation circuit output bit 404.

Returning to FIG. 6, timing signal generation circuit 670, in various examples, includes a modulo counter. In some examples, timing signal generation circuit 670 may include a modulo L*N counter that counts from the value of L*N (e.g., the waveform length (L) and the upsampling factor (N)) and wraps back around to zero once the value L*N is reached. As such, the timing signal generation circuit 670 output increments (or decrements) its output from an initial value, for example, 0 to a terminal value that is L*N−1. The timing signal generation circuit 670 outputs a timing signal 672 to waveform storage circuit 642 to cause the waveform storage circuit 642 to output each stored sample of the indexed waveform (e.g., the first set 532 and second set 534 of waveforms). As described above, the first set 532 of waveforms implemented by the waveform storage circuit 642 each include L₁*N samples (e.g., 7*32=224 samples) and the second set 534 waveforms implemented by the waveform storage circuit 642 each include L₂*N samples (e.g., 10*32=320 samples). The timing signal generation circuit 670 sequences the state of the waveform storage circuit 642 to output each of the samples sequentially as waveform signal 640 until the entire waveform is output. In other examples, the timing signal generation circuit 670 may assert a clock signal to the waveform storage circuit 642 to output the target waveform as waveform signal 640 in a burst operation.

Waveform storage circuit 642 (e.g., a waveform lookup table) may be implemented as Boolean logic and may be synthesized using a hardware description language provided to a circuit synthesization tool based on the functionality attributed to as described herein. In other examples, the waveform storage circuit 642 may include memory and the dither waveforms may be stored in the memory, for example, in a look-up table stored in the memory. As such, dither signal generation circuit 616 differs from dither signal generation circuit 216 in that dither signal generation circuit 616 does not include a filter (e.g., interpolation filter 242) and, other than negator 641, does not perform, or need to perform, any spreading sequence and/or interpolation filter calculations. Accordingly, the dither signal generation circuit 616 has a relatively small area for its footprint and consumes relatively little power, compared to a dither signal generation circuit that uses a spreading sequence sub-circuit and a filter (e.g., dither signal generation circuit 216).

As described above, the timing signal generation circuit 670 may be implemented as a counter and may advance its output in increments of M (discussed below) every clock cycle which may also be referred to as an accumulator. By adjusting the value of M, the dither signal generation circuit 616 can scale the bandwidth of the dither signal by increasing the effective bit rate of the noise generation circuit 630. Scaling the dither signal bandwidth and shifting the frequency of the dither signal may be desirable. For example, the transmitter (e.g., transmitter 100) may be transmitting a signal at 3.5 GHz, and the dither may be positioned at 0 Hz (e.g., DC). In another example, the transmitter may transmit a signal at 900 MHz, and if 0 Hz (i.e., DC) is deemed too close to 900 MHz, the dither may be positioned (by mixing, which is described below) at a higher frequency, such as 3 GHz. In any case, the dither is an undesired emission, and as such, is filtered out by an analog filter (e.g., at the output of the DSA 126), so as to not violate any relevant spectral emission requirements. The filtering may be performed using an analog filter or may be provided as part a “matching network” that is employed at the output before the signal is transmitted. The filtering complexity is determined by a combination of (1) the frequency separation from the dither signal to the desired signal (e.g., a wide frequency separation makes the dither filtering easier to implement), and (2) the power spectral density (PSD) of the dither signal (the power of the dither signal contained per Hz of frequency). The PSD impacts dither filtering because the requirement on emissions may be specified as a maximum allowed PSD level. As such, less attenuation is needed in the filter if the PSD is lower at the outset. Therefore, the dither bandwidth expansion may not significantly change the total power of the dither signal because the signal is spread over a wider bandwidth, thus reducing the PSD. This can help reduce the analog filtering complexity.

Bandwidth control of the dither signal may be performed by second selection circuit 662, clock management circuit 666, timing signal generation circuit 670. In various examples, second selection circuit 662 (e.g., a multiplexer) may include two or more inputs. The bandwidth scale factors (e.g., 1, 2, 3, etc.) may be provided as inputs to the second selection circuit 662. A bandwidth scale select signal 664 causes the second selection circuit 662 to select one of its input scale factors to provide as its output scale factor M. In various examples, dither signal generation circuit 616 may include a register 692 that can be programmed with a bandwidth scale factor. The bandwidth scale select signal 664 may be based on the value of the register 692. The selected scale factor M is provided to timing signal generation circuit 670 and to the clock management circuit 666. Timing signal generation circuit 670 may adjust the rate of timing signal 672 based on the scale factor M provided by second selection circuit 662.

The clock management circuit 666 outputs a clock signal 668 to the sequence controller 650. The clock signal 668 has a variable frequency that is dictated by the scale factor M. By selecting a larger scale factor M (e.g., 2 instead of 1), the frequency of clock signal 668 produced by the clock management circuit 666 is increased. A higher clock frequency causes sequence controller 650 to produce first LFSR update signal 652 and second LFSR update signal 653 as a higher frequency. The rate of progression for outputting waveform samples from the waveform storage circuit 642 is also modified to jump in increments of the same scale factor M. For example, if M is changed from 1 to 2, the clock signal 668 to sequence controller 650 is changed and sequence controller 650 updates the frequency of its signals in response.

The mixer 698 includes an input coupled to the output of first selection circuit 638 and another input coupled to an output of COS generator 696. The NCO 694 receives a frequency value from register 692 and the output of the NCO 694 is coupled to the input of COS generator 696. NCO 694 generates a phase signal that is determined by the value of register 692 and provides the phase signal to the COS generator 696. The COS generator 696 generates a cosine signal cos(wt) for the input of the mixer 698. The mixer 698 positions the dither signal at a frequency (which is determined by the value of register 692) that simplifies filtering for emission compliance. In one example, the dither signal is a real-valued (not complex) signal, and the mixer 698 shifts the frequency of the dither signal by multiplying the output signal from first selection circuit 638 by cos(wt). The frequency (w) may be user-configurable via register 692 by programming into the register 692 a value (e.g., a configuration 690) that the NCO 694 converts to the phase signal of the desired frequency.

Accordingly, the systems and methods disclosed herein may be used to improve the quality of a transmitted signal while reducing area and power consumption. In various examples, two or more spreading codes may be predetermined and a plurality of waveforms may be generated using the two or more spreading codes and an interpolation filter. In some examples, the plurality of generated waveforms may be stored in a waveforms storage circuit so that the system does not use a filter or spreading sequence sub-circuits. In other examples, a subset of the plurality of generated waveforms (e.g., half) may be hardcoded into the waveform storage circuit. In some examples, a sequence controller may receive spreading codes from a spreading code selector and receive the comparison (e.g., XOR) of the previous and current noise bits. The sequence controller may select a waveform index based on the received spreading codes and the comparison. A selection circuit (e.g., multiplexor) may output either the selected waveform or the inverse of the selected waveform as the dither signal based on the value of the previous random noise bit. Using the waveform storage circuit reduces die area and power consumption as compared to generating using sequence code generators and filters.

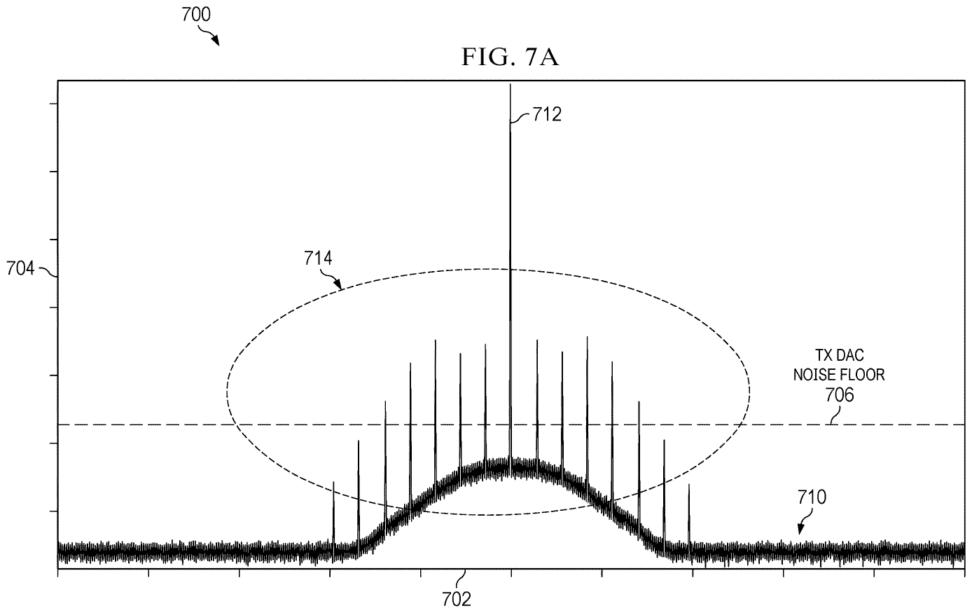

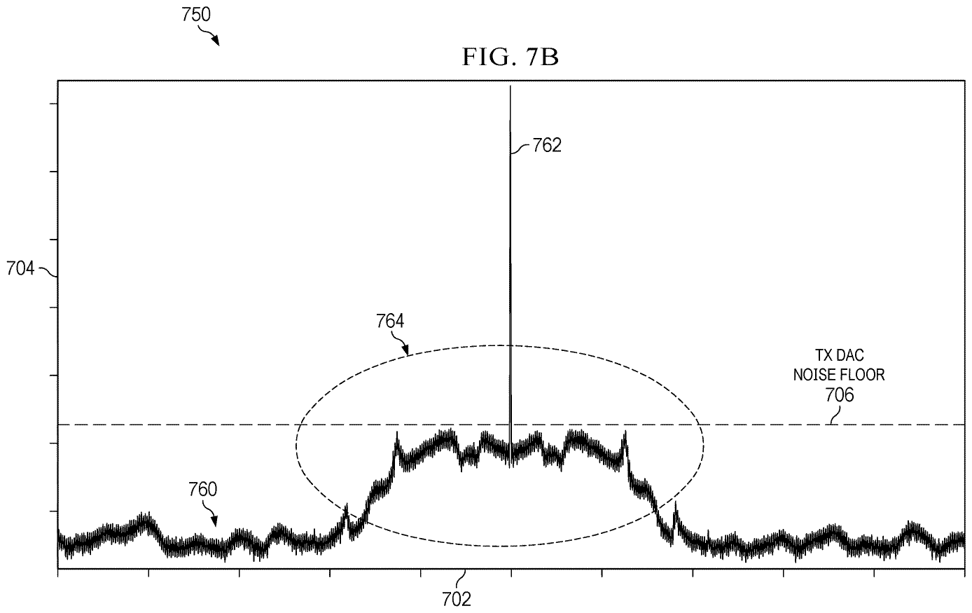

Referring now to FIGS. 7A and 7B, a frequency spectrum graph 700 and a frequency spectrum graph 750 are shown, respectively, according to various aspects of the present disclosure. Frequency spectrum graph 700 shown in FIG. 7A is from a circuit including a dither signal generation circuit that uses a single length spreading code. Frequency spectrum graph 750 shown in FIG. 7B is from a circuit including a dither signal generation circuit that uses multiple different length spreading codes, such as transmitter 100 including dither signal generation circuit 116 described in FIG. 1. Both frequency spectrum graph 700 and frequency spectrum graph 750 have a frequency axis 702 (e.g., the x-axis) and a spectral magnitude axis 704 (e.g., the y-axis). Additionally, both frequency spectrum graphs 700, 750 show a TX DAC noise floor 706 below which signals outside of the desired signal should remain.

Referring to FIG. 7A, frequency spectrum graph 700 shows the spectral components 710 of composite signal that is transmitted around a desired signal 712. As shown, most undesired spectral components 710 of the transmitted signal remain below the TX DAC noise floor 706. However, some of the spectral components 710 (e.g., intermodulation spurs 714) have a peak PSD that exceeds the TX DAC noise floor 706. When a dither signal is generated using a fixed spreading sequence length (e.g., L) and interpolated (e.g., by N) to the DAC rate, the spurious intermodulation components may result after passing through analog nonlinearity. As the composite signal goes through the NL in the TX analog, an intermodulation component involving a squared dither signal (e.g., d²) appears at the output. When the dither signal generation circuit uses a single fixed length spreading code, the d² component has a periodic structure resulting in the intermodulation spurs 714 in the vicinity of desired signal 712, as shown in FIG. 7A.

Referring to FIG. 7B, frequency spectrum graph 750 shows the spectral components 760 of a composite signal that is transmitted around a desired signal 762. In various examples, the frequency spectrum graph 750 may be the output of a system using dither signal generation circuit 116, dither signal generation circuit 216, or dither signal generation circuit 616 as described herein. As shown, the peak PSD of the intermodulation spurs 764 remains below the TX DAC noise floor 706. Moreover, because the dither signal generation circuit uses two or more spreading codes having different lengths, the intermodulation spurs 764 are not periodic. Therefore, the spectral components 760 of the composite signal remain below the TX DAC noise floor 706. This reduction in undesirable intermodulation components results from the breaking of periodic patterns in the squared dither signal (e.g., d²) owing to the randomized mix of spreading code lengths involved in the generation of the dither signal.

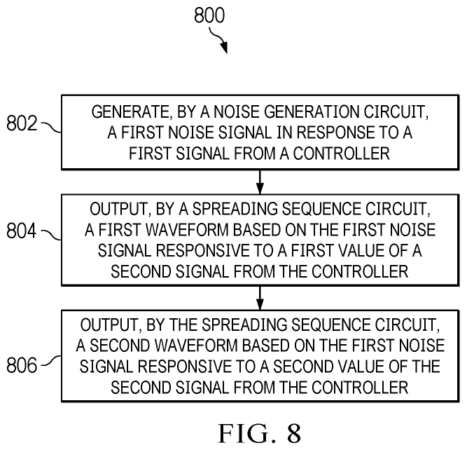

Referring now to FIG. 8, a flow diagram of a method 800 for generating a dither signal is illustrated, in accordance with various aspects of the present disclosure. In some examples, method 800 may be performed by dither signal generation circuit 216 described in FIG. 2. In other examples, method 800 may be performed by dither signal generation circuit 616 described in FIG. 6. Additional processes can be provided before, during, and after method 800.

At step 802, a noise generation circuit generates a first noise signal in response to a first signal from a controller. At step 804, a spreading sequence circuit outputs a first waveform based on the first noise signal responsive to a first value of a second signal from the controller. At step 806, the spreading sequence circuit outputs a second waveform based on the first noise signal responsive to a second value of the second signal from the controller.

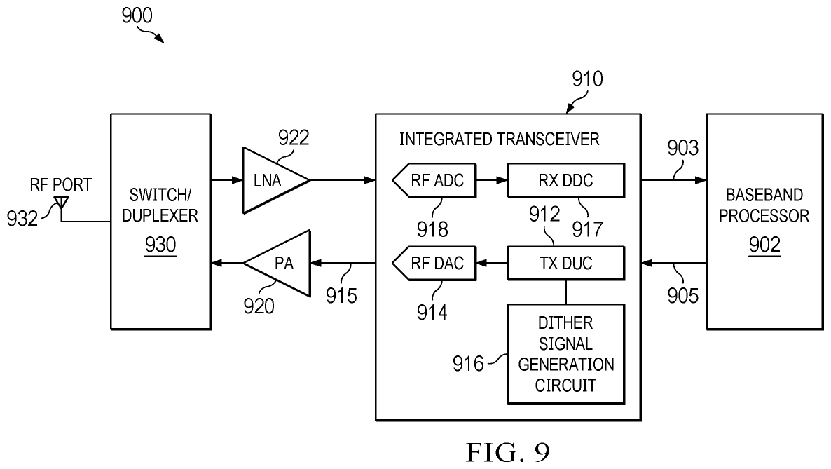

Referring now to FIG. 9, a system 900 including a dither signal generation circuit 916 as part of an integrated transceiver is shown, in accordance with various aspects of the present disclosure. Dither signal generation circuit 916 may be similar to dither signal generation circuits 116, 216, and 616 described above in FIGS. 1, 2, and 6, respectively. The integrated transceiver may be incorporated into a variety of electronic systems. Such systems include, as examples, wireless base stations, test systems, measurement systems, radar systems, and satellite communication systems. Some or all of such systems include one or more data converters (e.g., digital-to-analog converters or analog-to-digital converters) to which the dither signal generation circuit 916 (e.g., dither signal generation circuit 116, dither signal generation circuit 216, dither signal generation circuit 616) is coupled. FIG. 9 shows an example of a system such as a wireless base station that includes the transmitter with dither capability described herein. The system includes a baseband processor 902, an integrated transceiver 910 (e.g., integrated on a single semiconductor die), a power amplifier (PA) 920, a low noise amplifier (LNA) 922, a switch/duplexer 930, and an RF port 932. The integrated transceiver 910 includes a receive signal path including an RF ADC 918 coupled to a receive digital down converter (DDC) 917. The integrated transceiver 910 also includes a transmit signal path including an RF DAC 914 coupled to a transmit digital upconverter (TX DUC) 912. The TX DUC 912 includes any of the dither capabilities of dither signal generation circuit 216 and dither signal generation circuit 616 described herein in FIGS. 2 and 6, respectively. A received signal from the RF port 932 is provided to the LNA 922 via the switch/duplexer 930. The LNA 922 amplifies the signal and provides the amplified received signal to the RF ADC 918 where it is converted to a digital representation and downconverted by RX DDC 917 to a baseband frequency (signal 903) to be processed by baseband processor 902.

A baseband signal 905 to be transmitted from the baseband processor 902 is upconverted, with the addition of dither, by the TX DUC 912 and the higher frequency signal from the TX DUC 912 is provided to the RF DAC 914 which converts the signal to an analog signal 915. PA 920 amplifies the analog signal 915 from the RF DAC 914 and the switch/duplexer 930 provides the amplified analog signal to the RF port 932 for transmission by an antenna.

Accordingly, the systems and methods disclosed herein may be used to improve the quality of a transmitted signal. In various examples, the systems and methods may also reduce area and power consumption of a dither signal generation circuit. In various examples, two or more spreading codes having different lengths may be selected based on one or more characteristics. In some examples, a cost function may be used to select the two or more spreading codes. In some examples, two or more spreading sequence sub-circuits may use the selected spreading codes. In such examples, the outputs of the spreading sequence sub-circuits may be filtered to generate the dither signal. In other examples, a plurality of waveforms may be hardcoded into a waveform storage circuit. In various examples, a sequence controller may send instructions to the spreading sequence sub-circuits or the waveform storage circuit to generate output. In various examples, the control signals and output may be based on a previous and current random bit and a previous and current spreading code selection.

Finally, it should be understood that any of the above-described concepts can be used alone or in combination with any or all of the other above-described concepts. Although various examples have been disclosed and described, it is understood, recognized, and/or contemplated that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A device, comprising:
a dither signal generation circuit, comprising:
a controller configurable to generate a first signal and a second signal;
a noise generation circuit configurable to receive the first signal from the controller and generate a noise signal responsive to the first signal;
a spreading sequence circuit configurable to:
spread the noise signal to generate a first waveform using a first spreading code responsive to the second signal having a first value; and
spread the noise signal to generate a second waveform using a second spreading code responsive to the second signal having a second value.

2. The device of claim 1, wherein the dither signal generation circuit further comprises:
a first spreading sequence sub-circuit configurable to generate the first waveform;
a second spreading sequence sub-circuit configurable to generate the second waveform; and
a filter coupled to the first and second spreading sequence sub-circuits and configurable to filter the first waveform responsive to the second signal having the first value and the second waveform responsive to the second signal having the second value to generate a dither signal.

3. The device of claim 1, wherein the spreading sequence circuit further comprises:
a first spreading sequence sub-circuit configurable to generate the first waveform;
a second spreading sequence sub-circuit configurable to generate the second waveform;
a selection circuit coupled to the first and second spreading sequence sub-circuits and configurable to selectively output the first waveform in response to the second signal having the first value or the second waveform in response to the second signal having the second value; and
a filter coupled to the selection circuit and configurable to filter the first waveform or the second waveform selected by the selection circuit to generate a dither signal.

4. The device of claim 3, wherein:
the first spreading code has a first length; and
the second spreading code has a second length that is different than the first length.

5. The device of claim 4, wherein a length of the filter corresponds to a least of the first length and the second length multiplied by an upsample factor.

6. The device of claim 1, wherein the spreading sequence circuit further comprises:
a waveform storage circuit configurable to:
store a first set of values representing the first waveform and a second set of values representing the second waveform;
generate the first waveform using the first set of values responsive to the second signal having the first value; and
generate the second waveform using a second set of values responsive to the second signal having the second value.

7. The device of claim 6, wherein the spreading sequence circuit further comprises:
a negator configurable to receive an output of the waveform storage circuit; and
a selection circuit configurable to receive the output of the waveform storage circuit, an output of the negator, and a control signal, wherein the selection circuit outputs the first waveform responsive to the control signal having a first value and a third waveform responsive to the control signal having a second value.

8. The device of claim 7, further comprising:
a delay element configurable to receive the noise signal and output the control signal; and
a logic element configurable to receive the noise signal and the control signal and output a third signal to the controller, wherein the controller generates the second signal based in part on the third signal.

9. The device of claim 8, further comprising:
a spreading code selector configurable to receive the first signal and output a first code signal to the controller responsive to receiving the first signal, wherein the controller generates the second signal based on the third signal and the first code signal.

10. The device of claim 9, wherein:
the spreading code selector is further configurable to output a second code signal, and
the controller is further configurable to generate the second signal based on the third signal, the first code signal, and the second code signal.

11. A system, comprising:
a digital-to-analog converter (DAC) configurable to provide an output for a radio transmitter;
a dither signal generation circuit coupled to the DAC, the dither signal generation circuit including:
a controller configurable to provide a waveform index signal and a trigger signal;
a noise generation circuit coupled to the controller and configurable to generate a noise signal responsive to the trigger signal; and
a spreading sequence circuit coupled to the controller and configurable to spread the noise signal to generate a waveform based on the waveform index signal and the noise signal, wherein the spreading sequence circuit includes a first spreading sequence that generates a first waveform in response to the waveform index signal having a first value and a second spreading sequence that generates a second waveform in response to the waveform index signal having a second value.

12. The system of claim 11, wherein the dither signal generation circuit further comprises:
a spreading code selector coupled to the controller and configurable to output a code signal in response to the trigger signal, wherein the controller is configurable to provide the waveform index signal based on selecting the waveform index signal from a plurality of waveform index signals.

13. The system of claim 12, wherein the spreading sequence circuit includes:
a waveform storage circuit coupled to the controller and configurable output a plurality of waveforms based on the first and second spreading sequences, wherein the waveform storage circuit outputs a waveform of the plurality of waveforms based on the waveform index signal.

14. The system of claim 13, wherein the dither signal generation circuit further comprises:
a timing signal generation circuit coupled to the controller and the waveform storage circuit, the timing signal generation circuit configurable to receive a length signal from the controller and provide a timing signal to the waveform storage circuit, wherein
the waveform storage circuit outputs the waveform based on the timing signal and the waveform index signal.

15. The system of claim 11, wherein the radio transmitter is a high frequency radio transmitter.

16. A method, comprising:
generating, by a noise generation circuit, a first noise signal in response to a first signal from a controller;
outputting, by a spreading sequence circuit, a first waveform based on the first noise signal responsive to a second signal from the controller having a first value; and
outputting, by the spreading sequence circuit, a second waveform based on the first noise signal responsive to the second signal from the controller having a second value.

17. The method of claim 16, further comprising:
selecting, by the controller, a first spreading code from a plurality of spreading codes; and
outputting, by the controller, the second signal having the first value in response to selecting the first spreading code.

18. The method of claim 17, further comprising:
generating, by the noise generation circuit, a second noise signal in response to the first signal from the controller; and
generating, by a logic element, a comparison signal based on the first noise signal and the second noise signal;
wherein selecting the first spreading code includes:
receiving, by the controller, the comparison signal from the logic element;
receiving, by the controller, a third signal from a spreading code selector indicating the first spreading code;
receiving, by the controller, a fourth signal from the spreading code selector indicating a second spreading code; and
selecting, by the controller, the first spreading code based on the comparison signal, the third signal, and the fourth signal.

19. The method of claim 18, further comprising:
selecting a first set of spreading codes based on a characteristic, the characteristic selected from a characteristic group consisting of peak power spectral density of an out-of-band dither signal, peak power spectral density of a dither squared signal, peak-to-average power ratio of the out-of-band dither signal, peak to kth percentile ratio of the out-of-band dither signal;
selecting a first subset of spreading codes from the first set of spreading codes such that the first subset of spreading codes have lengths that are co-prime;
selecting a second subset of spreading codes from the first subset of spreading codes such that the second subset of spreading codes minimize a cost function based on the characteristic group; and
selecting the first spreading code from the second subset of spreading codes in response to the second signal.

20. The method of claim 18, wherein:
the first spreading code has a first length; and
the second spreading code has second length that is different than the first length.
